(19) United States
(12) Patent Application Publication
(10) Pub. No.: US 2016/0183487 A1
(43) Pub. Date: Jun. 30, 2016

(54) System and Method for Detecting the Absence of a Thin Nutrient Film in a Plant Growing Trough

(71) Applicant: MICROWARE LIMITED, Gibraltar (GI)

(72) Inventor: Bentsion KABAKOV, QUEENSWAY QUAY (GI)

(21) Appl. No.: 14/582,266

(22) Filed: Dec. 24, 2014

(51) Int. Cl. A01G 31/02; G06K 7/10

(52) U.S. Cl. CPC A01G 31/02; G06K 7/10366

(57) ABSTRACT

A system for detecting the absence of a thin nutrient film in a plant growing trough includes a trough for use in a thin-nutrient-film agricultural system, the trough having a trough base across which the thin-nutrient-film passes. A high frequency RFID tag, located in or below the trough base, is operable to receive an interrogator signal and to transmit an authentication signal. When an RFID reader passes over the RFID tag and transmits an interrogator signal, an authentication signal is generated only in the absence of a shielding layer of nutrient film, thereby indicating a failure of the nutrient film circulatory system.

### FIELD AND BACKGROUND OF THE INVENTION

The present invention relates to plant treatment systems. It is known that many soilless plant growing techniques, such as hydroponics and aeroponics, use nutrient solutions in order to provide the appropriate nutrients to the plants. Typically, the plants are grown in a growing container, such as a growing trough or the like. Conventional hydroponic growing techniques employ a standing nutrient solution in which the plant roots develop. In some instances, the nutrient solution is dripped in to the growing trough from a reservoir or the like through an intake opening in the growing trough. The nutrient solution is absorbed by the roots of the plants. The excess, or run-off, nutrient solution may then exit the growing trough through a drain in the growing trough and can be recirculated to the reservoir for reuse. This results in a constant flow of nutrient solution to the roots of the plants in the growing trough. However, because there is no soil or standing nutrient solution to act as a buffer, any disruption in the flow of the nutrient solution leads to rapid plant death as a result of the dehydration of the roots. Moisture sensor devices may be integrated into growing troughs for detecting any disruptions in nutrient flow. However, such sensor devices would tremendously increase costs, since hydroponic growing areas typically use numerous growing troughs which frequently need to be replaced between growing cycles.

### SUMMARY OF THE INVENTION

The present invention is a system and method for providing a functionality for detecting the absence of a thin nutrient film in a plant growing trough.

According to the teachings of the present invention there is provided, a system for detecting the absence of a thin nutrient film in a plant growing trough comprising: (a) a trough for use in a thin-nutrient-film agricultural system, said trough having a trough base across which the thin-nutrient-film passes; and (b) a high frequency RFID tag located in or below said trough base and operable to receive an interrogator signal and to transmit an authentication signal, such that, wherein an RFID reader passes over said RFID tag and transmits an interrogator signal, an authentication signal is generated only in the absence of a shielding layer of nutrient film, thereby indicating a failure of the nutrient film circulatory system.

According to a further feature of an embodiment of the present invention, the system for detecting the absence of a thin nutrient film further comprises: (a) a transport device deployed for moving above said trough; and (b) an RFID reader mounted to said transport device and operable to transmit an interrogator signal and to receive an authentication signal.

According to a further feature of an embodiment of the present invention, the transport device is a gantry.

According to a further feature of an embodiment of the present invention, the system for detecting the absence of a thin nutrient film further comprises: (a) a nutrient solution circulatory system configured for: (i) introducing the thin nutrient film to a first end of said growing trough; and (ii) receiving a drained excess of the thin nutrient film from a second end of said growing trough, such that the thin-nutrient-film is recirculated through said growing trough, thereby maintaining cultivation conditions for plants in said growing trough.

According to a further feature of an embodiment of the present invention, the RFID tag is a passive RFID tag.

According to a further feature of an embodiment of the present invention, the RFID tag is an active RFID tag.

According to a further feature of an embodiment of the present invention, the system for detecting the absence of a thin nutrient film further comprises: a low frequency RFID tag located in or below said trough base and operable to receive a low frequency interrogator signal and to transmit a low frequency authentication signal, wherein said RFD reader is further operable to transmit a low frequency interrogator signal and receive a low frequency authentication signal, such that, wherein said RFID reader passes over said low frequency RFID tag and transmits an interrogator signal, an authentication signal is generated.

According to a further feature of an embodiment of the present invention, the system for detecting the absence of a thin nutrient film further comprises a second high frequency RFID tag mounted to a sidewall of said trough above the thin-nutrient-film and operable to receive a high frequency interrogator signal and to transmit a high frequency authentication signal, such that, wherein said RFID reader passes over said second high frequency RFID tag and transmits an interrogator signal, an authentication signal is generated by said second high frequency RFID tag.

According to the teachings of the present invention there is provided, a method for detecting the absence of a thin nutrient film in a plant growing trough, comprising the steps of: (a) obtaining a trough having a trough base across which a thin-nutrient-film passes; (b) placing a high frequency RFID tag in or below said trough base; (c) passing an RFID reader over said RFID tag and transmitting an interrogator signal when said RFID reader passes over said REID tag; and (d) receiving an authentication signal only in the absence of a shielding layer of nutrient film, thereby indicating a failure of the nutrient film circulatory system.

According to a further feature of an embodiment of the present invention, the method for detecting the absence of a thin nutrient film in a plant growing trough further comprises the steps of: (a) obtaining a transport device deployed for moving above said trough; and (b) mounting said RFID reader to said transport device.

According to a further feature of an embodiment of the present invention, in the method for detecting the absence of a thin nutrient film in a plant growing trough, the RFID tag is a passive RFID tag.

According to a further feature of an embodiment of the present invention, in the method for detecting the absence of a thin nutrient film in a plant growing trough, the RFID tag is an active RFID tag.

### BRIEF DESCRIPTION OF THE DRAWINGS

The invention is herein described, by way of example only, with reference to the accompanying drawings, wherein:

FIG. 1 is a schematic diagram of a system for detecting the absence of a thin nutrient film according to an embodiment of the invention;

FIG. 2 illustrates a process for detecting the absence of a thin nutrient film according to an embodiment of the invention;

FIG. 3 is a schematic diagram of a series of growing troughs with RFID tags according to an embodiment of the invention; and

FIG. 4 is a schematic diagram of a system for detecting the absence of a thin nutrient film and for performing a system functionality check according to an embodiment of the invention.

### DESCRIPTION OF THE PREFERRED EMBODIMENTS

The present invention is a system and method for providing a functionality for detecting the absence of a thin nutrient film in a plant growing trough.

The principles and operation of a system and method according to the present invention may be better understood with reference to the drawings and the accompanying description.

The present invention is applicable to various techniques of soilless crop growing, and is of particular value when applied to mechanized production-line-type growing areas in which plants are cultivated in growing troughs via hydroponics or the like, using a thin nutrient film technique, which advance from a planting location to a harvesting location, stopping along the way to be aligned with an outlet for supplying a nutrient film. In a thin nutrient film technique, a shallow stream of a nutrient solution is recirculated past the plant roots in the growing trough. The nutrient circulation system typically includes a reservoir, a pump drawing solution from the reservoir and delivering it via a system of tubes for delivery to the troughs, a drainage arrangement for collecting drained solution from the troughs back to the reservoir, and a solution adjustment system for maintaining levels of water and nutrients in the solution within a desired range. The nutrient circulation system is not per se part of the present invention, and is therefore illustrated here only schematically. The nutrient solution is dripped in to the growing trough from a reservoir or the like. The growing trough is at a slight incline such that when the nutrient solution is introduced at one end of the growing trough, the solution subsequently drips down to lower end of the trough, supplying a mixture of oxygen and nutrients to the plant roots. The nutrient solution is absorbed by the roots of the plants and the excess, or run-off, nutrient solution may then exit the growing trough through a drain or the like. The nutrient solution can then be recirculated to the reservoir for reuse via a pump or the like. The recirculation of the nutrient solution helps to maintain the cultivation conditions for the plants in the growing troughs. The potential applications of the present invention should not be limited to the applications used for the purposes of illustrating the principles and operation of a system and corresponding components according to the present invention.

RFID systems known in the art use RFID readers to be able to identify RFID tags attached to objects when a reader and a tag are within a certain range. The range is typically dependent on the frequency band in which the reader and the tag operate. For example, tags and readers operating in the low frequency (LF) band typically have a range of approximately 10 cm, while tags and readers operating in the ultra high frequency (UHF) band typically have a variable range of approximately 1-12 meters. An RFID system may be classified by the type of RFID reader and RFID tag. Types of RFID systems, include, but are not limited to, passive reader active tag systems, active reader passive tag systems, and active reader active tag systems. Typically, passive RFID tags are less expensive and smaller than active RFID tags because passive RFID tags do not have a power supply such as a battery or the like. Passive RFID tags typically use the energy from received signals to provide power to the circuitry in the RFID tag and to generate the transmission signals. A battery assisted passive tag uses a small battery to generate the transmission signals.

The terms RFID tag and RFID reader refer broadly to various technologies and/or standards which are based on electronic tag/reader communication and should not be limited to a specific standard. For the purposes of this document, the term RFID tag and RFID reader can include electronic devices used in near field communication (NFC), which allows devices to establish radio communication with each other by bringing the devices within sufficient proximity of each other.

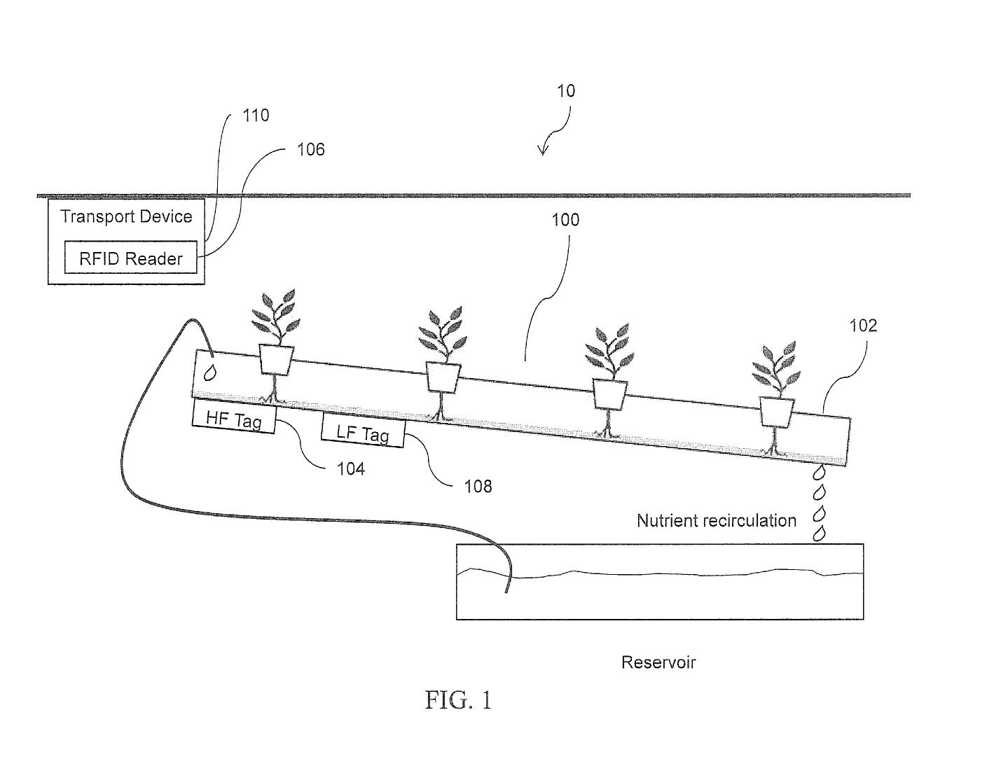

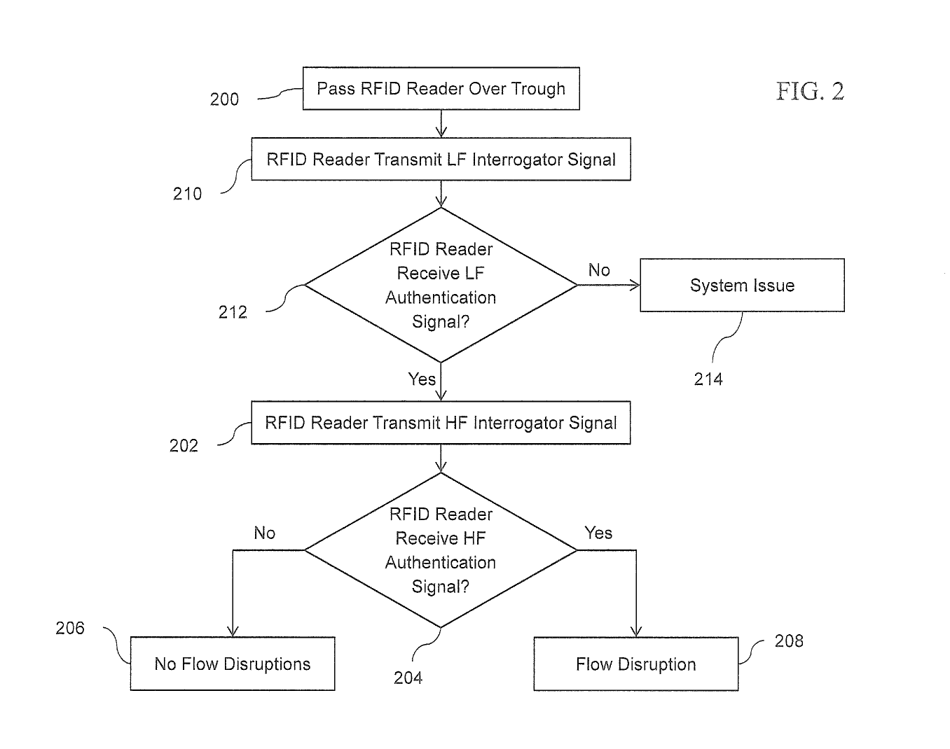

Referring now to the drawings, FIG. 1 is an overall schematic diagram of a system 10 and corresponding components for providing a functionality for detecting the absence of a thin nutrient film in a plant growing trough. With reference to FIG. 1, major elements of system 10 preferably include a growing trough with RFID tag 100. Preferably, an RFID reader 106 is positioned to move above growing trough with RFID tag 100. Growing trough with RFID tag 100 preferably includes an RFID tag 104 and a growing trough 102 for growing plants using a thin nutrient film technique. RFID tag 104 is preferably positioned in or below the base of growing trough 102 such that when a thin nutrient film is supplied to the plants in growing trough 102, the thin nutrient film runs along the base of growing trough 102 and is interposed thus between RFID tag 104 and the RFID reader 106. The thin nutrient film can be made of various solutions maintained at suitable concentrations and pH, all as is known in the art of hydroponics and aeroponics. It is preferred that RFID tag 104 and RFID reader 106 operate in a frequency band such that when the thin nutrient film is interposed between RFID tag 104 and RFID reader 106, the thin nutrient film acts to block the signals transmitted by RFID tag 104 and RFID reader 106. More preferably, RFID tag 104 and RFID reader 106 operate in the UHF band which is between 300 MHz and 3 GHz. RFID tags operating in the UHF frequency band are hereinafter referred to as “high frequency RFID tags”, while tags operating at lower frequencies are referred to collectively for the purpose of this application as “low frequency RFID tags”. Referring also to FIG. 2, the operational steps of detecting the absence (or presence) of a thin nutrient film according to system 10 are depicted for illustration purposes. When RFID reader 106 passes 200 over the growing trough with high frequency RFID tag 100, the thin nutrient film acts to block the UHF signals transmitted by RFID reader 106 and/or high frequency RFID tag 104. The absence of the receipt of an HF authentication signal 204 from high frequency RFID tag 104 subsequent to the transmission of an HF interrogator signal 202 signifies that there are no disruptions 206 in the flow of the thin nutrient film to the plants in growing trough 102. The receipt of an HF authentication signal 204 from high frequency RFID tag 104 signifies that there is a disruption 208 of the flow of the thin nutrient film to the plants in growing trough 102. Types of disruptions may include, but are not limited to, a growing trough out of alignment with a flow outlet, a blocked flow outlet, and a leak in the piping system which provides the thin nutrient film to growing trough 102. The lack of the reception of the authentication signal may be the result of the thin nutrient film blocking high frequency RFID tag 104 from receiving the interrogator signal transmitted by RFID reader 106, blocking RFID reader 106 from receiving high frequency RFID tag 104 authentication signal in cases where the thin nutrient film does not block high frequency RFID tag 104 from receiving the interrogator signal, or any combination thereof. It is preferable that high frequency RFID tag 104 is a passive RFID tag and that RFID reader 106 is an active reader. Preferably, RFID reader 106 is associated with a control device. Preferably RFID reader 106 is associated with a processor coupled to a data storage medium such as a memory. The processor can be any number of computer processors including, but are not limited to, a microprocessor, an ASIC, a DSP, a state machine, and a microcontroller. Such processors include, or may be in communication with computer readable media, which stores program code or instruction sets that, when executed by the processor, cause the processor to perform actions. Types of computer readable media include, but are not limited to, electronic, optical, magnetic, or other storage or transmission device capable of providing a processor with computer readable instructions. The control device and processor combination is preferably configured to provide a notification of a disruption to the flow of the thin nutrient film. The processor may be further coupled to a communication device in order to send disruption notification via a wired or wireless network to local and/or remote destinations.

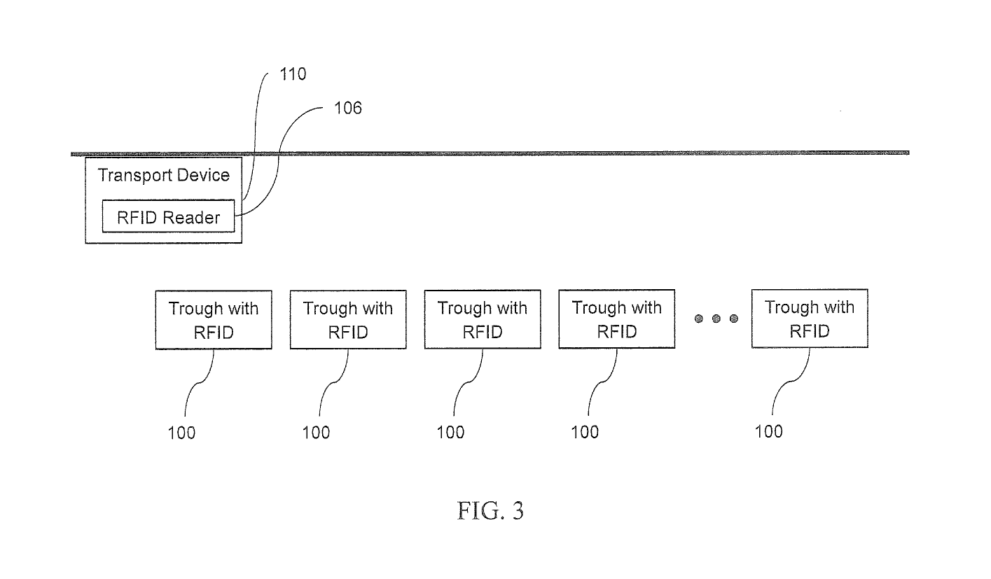

According to certain preferred embodiments, RFID reader 106 is mounted to a transport device 110 for moving across a growing area. Growing trough 102 is preferably positioned in the growing area such that when transport device 110 passes growing trough 102, RFID reader 106 passes over growing trough 102 and is in range of high frequency RFID tag 104. The positioning of RFID reader 106 over growing trough 102 allows RFID reader 106 to check for the absence of the thin nutrient film. Types of transport devices 110 include, but are not limited to, a gantry, a cart, a ceiling mounted trolley, or any suitable device for moving an RIM reader 106 across a growing area. The movement of transport device 110 may be facilitated by any suitable medium, including, but not limited to, manual movement by a human, movement actuated by a control system, or automated movement. Although the system described thus far has pertained to a transport device 110 moving an RFID reader 106 across a growing area allowing RFID reader 106 to pass over a single growing trough 102, system 10 is of particular value when transport device 110 passes over a sizable array of growing troughs with RFID 100. With reference to FIG. 3, in such an embodiment, each growing trough 102 has a high frequency RFID tag 104 preferably located in or below the base of growing trough 102 as depicted in FIG. 1. The path traversed by transport device 110 facilitates the process of efficiently checking for the absence of thin nutrient film in each of growing troughs 102. Such an embodiment is a cost effective alternative to placing moisture sensors in a large number of growing troughs. Such an embodiment is also a cost effective alternative to using active RFID tags which require batteries for supply power and/or generating signals. It is most preferable that transport device 110 is a gantry with wheels configured to operate along the perimeter of the growing area.

According to certain preferred embodiments, an additional RFID tag 108, operating outside of the UHF band, is placed in or below the base of the same growing trough 102 as high frequency RFID tag 104. Preferably, additional RFID tag 108 is operable in the LF band which is between 30 kHz and 300 kHz. Preferably, the thin nutrient film is composed of ingredients which allow signals in the LF band to pass through the shielding layer of thin nutrient film that blocks UHF signals. RFID reader 106 is preferably operable to transmit both UHF and LF interrogator signals. LF RFID tag 108 is preferably operable to receive the LF interrogator signal and to transmit an LF authentication signal. RFID reader 106 is preferably operable to receive both the high frequency RFID authentication signal and the LF RFID authentications signal. LF RFID tag 108 are preferably used to indicate the position of growing troughs, the plant type or types in a given trough, and plant treatment type for the plant or plants in a growing trough. The LF RFID tags may also be used for inventory and product tracking. Since LF RFID tag 108 and high frequency RFID tag 104 operate in different frequency bands, LF signals and the UHF signals can be easily distinguished by RFID reader 106. Although the system described thus far has pertained to a growing trough 102 with a high frequency RFID tag 104 and an LF RFID tag 108, other embodiments are possible in which a plurality of LF RFID tags 108 are placed in the base of the same growing trough 102 as high frequency RFID tag 104. In such an embodiment, each LF RFID tag 108 is preferably operable at a different frequency in the LF band. Preferably, the operating frequencies of LF RFID tags 108 are appropriately spaced such that the signals of LF RFID tags 108 operating at adjacent frequencies do not interfere with each other and can be distinguished by RFID reader 106. For example, if two LF RFID tags 108 are used, one LF RFID tag 108 may be operable at 40 kHz and the other LF RFID tag 108 may be operable at 120 kHz. It is preferred that the memory coupled to the processor associated with RFID reader 106 includes a database in order to match LF RFID tags 108 with plant types and plant treatment types. This is of particular value when the crop growing area is subdivided into different regions for different plants, where the different plants may require different treatment types. While the use of LF RFID tags 108 in growing troughs 102 can be used to collect information about the positioning and contents of growing troughs 102, LF RFID tags 108 also have the added advantage of being able to provide a system functionality check to check if there are any system issues. Since the LF RFID tags 108 are not shielded, when RFID reader 106 passes 200 over LF RFID tags 108, RFID reader 106 should receive an LF authentication signal 212 from each LF RFID tag 108 in response to LF interrogator signals 210. However, if when transport device 110 passes over growing troughs 102 and RFID reader 106 does not receive authentication 212 signals from each LF RFID tag 108, there is an indication that a system issue 214 is present Types of system issues may include, but are not limited to, a growing trough 102 being out of alignment, a malfunctioning RFID reader 106, and a malfunctioning LF RFID tag 108. The above described operational steps are depicted in FIG. 2. While the depiction in FIG. 2 shows the system check steps as being performed prior to the transmission of the HF interrogator signal 202, alternatively, the system check steps may be performed in parallel with the transmission of the HF interrogator signal 202. The receipt of an LF authentication signal 212 provides more reliability to the flow disruption 208 indication of HF RFID tags 104.

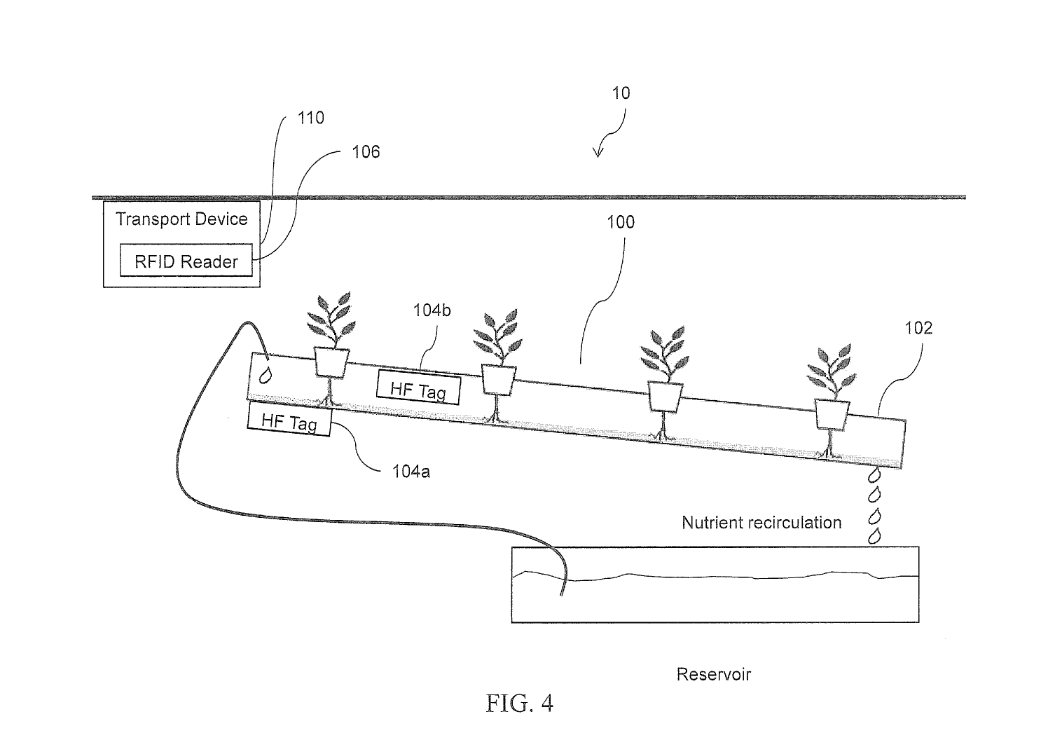

Although the system described thus far has pertained to a growing trough 102 with a single HF RFID tag 104 for detecting the absence of a thin nutrient film and a single LF RFID tag 106 for performing a system functionality check, other embodiments are possible in which a second HF RFID tag 104b is positioned in growing trough 102 in order to perform a system functionality check. With reference to FIG. 4, in such an embodiment, second HF RFID tag 104b is preferably mounted in a sidewall of growing trough 102 such that second HF RFID tag 104b is not shielded by the thin nutrient film. Second HF RFID tag 104b would perform the same functionality as the LF RFID tag 106 as previously described. As previously described, a first HF RED tag 104a is preferably positioned in or below the base of growing trough 102 to detect the absence of the thin nutrient film. Preferably, first and second HF RFID tags 104a,104b have different encoding to provide an indication as to whether the intended use of an interrogated tag is for detecting the absence of the thin nutrient film or for the system functionality check.

Although the system described thus far has pertained to a growing trough 102 with a single high frequency RFID tag 104, other embodiments are possible in which multiple high frequency RFID tags are placed in or below the base of a growing trough 102. In such an embodiment, the use of multiple high frequency RFID tags may add redundancy to system 10 to help overcome malfunctions in one or more high frequency MD tags 104. For example, three high frequency RFID tags 104 may be placed in or below the base of a growing trough 102. Preferably, the operating frequencies of the high frequency RFID tags 104 are appropriately spaced such that the signals of the high frequency RFID tags 104 operating at adjacent frequencies do not interfere with each other and can be distinguished by RFID reader 106. In such an embodiment, if one of the high frequency RFID tags 104 malfunctions during a disruption to the flow of the thin nutrient film, RFID reader 106 will preferably receive authentication signals from the two properly functioning high frequency RFID tags 104, and decision based on majority logic would be made indicating that there is a flow disruption. In such an embodiment, the processor associated with RFID reader 106 is preferably configured to perform any additional functions for performing such majority logic decisions.

Although the system described thus far has pertained to the use of a passive high frequency RFID tag 104 for use in detecting the absence of a thin nutrient film in a growing trough 102, other embodiments are possible in which high frequency RFID tag 104 is an active tag (for example a battery assisted passive tag). In such an embodiment, active RFID tag 104 maintains an indefinite sleep mode and does not transmit unless awoken by an interrogation signal transmitted by RFID reader 106.

It will be appreciated that the above descriptions are intended only to serve as examples, and that many other embodiments are possible within the scope of the present invention as defined in the appended claims.

What is claimed is:

1. A system for detecting the absence of a thin nutrient film in a plant growing trough comprising:
(a) a trough for use in a thin-nutrient-film agricultural system, said trough having a trough base across which the thin-nutrient-film passes; and
(b) a high frequency RFID tag located in or below said trough base and operable to receive an interrogator signal and to transmit an authentication signal,
such that, wherein an RFID reader passes over said RFID tag and transmits an interrogator signal, an authentication signal is generated only in the absence of a shielding layer of nutrient film, thereby indicating a failure of the nutrient film circulatory system.

2. The system of claim 1, further comprising:
(a) a transport device deployed for moving above said trough; and
(b) an RFID reader mounted to said transport device and operable to transmit an interrogator signal and to receive an authentication signal.

3. The system of claim 2, wherein said transport device is a gantry.

4. The system of claim 1, further comprising:
(a) a nutrient solution circulatory system configured for:
(i) introducing the thin nutrient film to a first end of said growing trough; and
(ii) receiving a drained excess of the thin nutrient film from a second end of said growing trough;
such that the thin-nutrient-film is recirculated through said growing trough, thereby maintaining cultivation conditions for plants in said growing trough.

5. The system of claim 1, wherein said RFID tag is a passive RFID tag.

6. The system of claim 1, wherein said RFID tag is an active RFID tag.

7. The system of claim 1, further comprising a low frequency RFID tag located in or below said trough base and operable to receive a low frequency interrogator signal and to transmit a low frequency authentication signal, wherein said RFID reader is further operable to transmit a low frequency interrogator signal and receive a low frequency authentication signal, such that, wherein said RFID reader passes over said low frequency RFID tag and transmits an interrogator signal, an authentication signal is generated.

8. The system of claim 1, further comprising a second high frequency RFID tag mounted to a sidewall of said trough above the thin-nutrient-film and operable to receive a high frequency interrogator signal and to transmit a high frequency authentication signal,
such that, wherein said RFID reader passes over said second high frequency RFID tag and transmits an interrogator signal, an authentication signal is generated by said second high frequency RFID tag.

9. A method for detecting the absence of a thin nutrient film in a plant growing trough, comprising the steps of:
(a) obtaining a trough having a trough base across which a thin-nutrient-film passes;
(b) placing a high frequency RFID tag in or below said trough base;
(c) passing an RFID reader over said RFID tag and transmitting an interrogator signal when said RFID reader passes over said RFID tag; and
(d) receiving an authentication signal only in the absence of a shielding layer of nutrient film, thereby indicating a failure of the nutrient film circulatory system.

10. The method of claim 9, further comprising the steps of:
(a) obtaining a transport device deployed for moving above said trough; and
(b) mounting said RFID reader to said transport device.

11. The method of claim 10, wherein said RFID tag is a passive RFID tag.

12. The method of claim 10, wherein said RFID tag is an active RFID tag.
